(19) United States
(12) Patent Application Publication
(10) Pub. No.: US 2017/0048687 A1
(43) Pub. Date: Feb. 16, 2017

(54) SYSTEM AND METHOD FOR DETECTING A HANDSHAKE

(71) Applicant: TREK TECHNOLOGY (SINGAPORE) PTE LTD, Singapore (SG)

(72) Inventor: Wayne TAN, Singapore (SG)

(73) Assignee: TREK Technology (Singapore) Ptd. Ltd., Singapore (SG)

(21) Appl. No.: 15/118,623

(22) PCT Filed: Feb. 12, 2015
(86) PCT No.: PCT/SG2015/000042

§ 371 Date: Aug. 12, 2016

Related U.S. Application Data
(60) Provisional application No. 61/938,852, filed on Feb. 12, 2014.

(51) Int. Cl. H04W 4/20; H04W 4/02; H04W 12/00; H04W 4/00; H04L 12/26; H04W 76/02; H04B 1/3827; H04M 1/2745

(52) U.S. Cl. CPC H04W 4/206; H04B 1/385; H04W 4/027; H04M 1/274516; H04W 4/008; H04L 43/103; H04W 76/023; H04W 12/00

(57) ABSTRACT

A system and method for detecting a handshake is described, the system comprising a first electronic wristband and a second electronic wristband. The first electronic wristband comprises a first processing unit, a first accelerometer and a first wireless transceiver module. The first processing unit is configured to receive acceleration data from the first accelerometer and determine a current state of the first electronic wristband. The second electronic wristband comprises a second processing unit, a second accelerometer and a second wireless transceiver module. The second processing unit is configured to receive acceleration data from the second accelerometer and determine a current state of the second electronic wristband. The first processing unit is configured to detect the handshake when, the current state of the first electronic wristband determined by the first processing unit indicates that the first electronic wristband is shaking, occurs at substantially the same time the first wireless transceiver module receives a broadcast packet from the second wireless transceiver, wherein the current state of the second electronic wristband in the broadcast packet indicates that the second electronic wristband is shaking.

### FIELD OF THE INVENTION

The invention pertains to a system and method for detecting a handshake using electronic wristbands or wrist-wearable devices.

### BACKGROUND

Wearable technology is becoming more prevalent in our society. In particular, electronic wristbands or wrist-wearable devices are becoming increasingly popular, with functionalities such as music and lifestyle displays, activity and fitness tracking, payment or ID authentication, and social sharing and interaction capabilities. In expanding its social sharing and interaction capabilities, it would be advantageous to have a convenient and easy way to initiate the exchange of information among electronic wristbands. For instance, if a handshake motion is detected, this could prompt the electronic wristbands to exchange name card information. This would greatly enhance the experience and speed of meeting peers or business contacts, and do away with the archaic act of name card swapping.

A typical method to detect a handshake motion would be to embed an accelerometer into the electronic wristband to detect when a person moves his wrist. However, this could result in many false positives as an accelerometer is unable to distinguish whether the person is actually shaking hands with another person or merely swinging his hand while dancing, jogging etc.

It is therefore an object of an invention to solve the above deficiencies and at least to provide a novel system and method for detecting a handshake.

### SUMMARY OF INVENTION

According to a first aspect of the invention, a system for detecting a handshake is described, the system comprising a first electronic wristband worn on a wrist of a first person and a second electronic wristband worn on a wrist of a second person. The first electronic wristband comprising a first processing unit and a first accelerometer, the first processing unit configured to receive acceleration data from the first accelerometer at a polling interval or upon an interrupt, and configured to determine at the polling interval, a current state of the first electronic wristband from the acceleration data. The first electronic wristband further comprises a first wireless transceiver module, the first wireless transceiver module configured to send broadcast packets at a broadcasting interval to a second wireless transceiver module, wherein each broadcast packet contains the current state of the first electronic wristband and an identifier of the first wireless transceiver module. The second electronic wristband comprising a second processing unit and a second accelerometer, the second processing unit configured to receive acceleration data from the second accelerometer at the polling interval or upon the interrupt, and configured to determine at the polling interval, a current state of the second electronic wristband from the acceleration data. The second electronic wristband further comprises the second wireless transceiver module, the second wireless transceiver module configured to send broadcast packets at the broadcasting interval to the first wireless transceiver module, wherein each broadcast packet contains the current state of the second electronic wristband and an identifier of the second wireless transceiver module. Wherein the first processing unit is configured to detect the handshake when, the current state of the first electronic wristband determined by the first processing unit indicates that the first electronic wristband is shaking, occurs at substantially the same time the first wireless transceiver module receives the broadcast packet from the second wireless transceiver module, wherein the current state of the second electronic wristband in the broadcast packet indicates that the second electronic wristband is shaking.

Preferably the first processing unit determines that the current state of the first electronic wristband indicates that the first electronic wristband is shaking when the acceleration readings have at least three positive-to-negative cycles in the X-axis or Y-axis or Z-axis direction.

Preferably the second processing unit determines that the current state of the second electronic wristband indicates that the second electronic wristband is shaking when the acceleration readings have at least three positive-to-negative cycles in the X-axis or Y-axis or Z-axis direction.

Preferably the system further comprises a first mobile device paired with the first wireless transceiver module, a second mobile device paired with the second wireless transceiver module, and a server, the server communicatively connected to the first mobile device and the second mobile device, wherein the first wireless transceiver module and first mobile device pair, and the second wireless transceiver module and second mobile device pair, exchange name card information via the server.

Preferably the server is configured to implement security checks prior to the exchange of name card information.

Preferably the first wireless transceiver module is further configured to locate the second wireless transceiver module via the identifier of the second wireless transceiver module, and configured to establish a peer to peer connection with the second wireless transceiver module to exchange name card information.

Preferably the first processing unit determines that the current state of the first electronic wristband indicates that the first electronic wristband is flipping, when the acceleration data indicates a change in orientation of the first accelerometer.

Preferably the first electronic wristband further comprises a first altimeter, and the first processing unit is further configured to receive altitude data from the first altimeter at the polling interval, and further configured to determine the current state of the first electronic wristband from the altitude data; and preferably the second electronic wristband further comprises a second altimeter, and the second processing unit is further configured to receive altitude data from the second altimeter at the polling interval, and further configured to determine the current state of the second electronic wristband from the altitude data.

Preferably the first processing unit determines that the current state of the first electronic wristband indicates that the first electronic wristband is being raised, when the altitude data indicate an increase in altitude greater than 0.5 meters.

Preferably the first processing unit determines that the current state of the first electronic wristband indicates that the first electronic wristband is being lowered, when the altitude data indicate a decrease in altitude greater than 0.5 meters.

Preferably the first wireless transceiver module or the second wireless transceiver module is any one of the following: an ANT transceiver module, a Bluetooth LE transceiver module and a Wi-Fi transceiver module.

Preferably the identifier of the first wireless transceiver module or the identifier of the second wireless transceiver module is a MAC address.

Preferably the polling interval is every 200 milliseconds.

Preferably the broadcasting interval is every 300 milliseconds.

According to a second aspect of the invention, a method for detecting a handshake, the method comprising the steps of using a first accelerometer to measure acceleration data, the first accelerometer comprised in a first electronic wristband worn on a wrist of a first person, the first electronic wristband further comprising a first processing unit and a first wireless transceiver module; and determining with the first processing unit and from the acceleration data at a polling interval, that a current state of the first electronic wristband indicates that the first electronic wristband is shaking. The method further comprises the steps of sending with the first wireless transceiver module, broadcast packets at a broadcasting interval to a second wireless transceiver, wherein each broadcast packet contains the current state of the first electronic wristband and an identifier of the first wireless transceiver module; and using a second accelerometer to measure acceleration data, the second accelerometer comprised in a second electronic wristband worn on a wrist of a second person, the second electronic wristband further comprising a second processing unit and the second wireless transceiver. The method further comprises the steps of determining with the second processing unit and from the acceleration data at the polling interval, that a current state of the second electronic wristband indicates that the second electronic wristband is shaking; and sending with the second wireless transceiver module, broadcast packets at the broadcasting interval to the first wireless transceiver, wherein each broadcast packet contains the current state of the second electronic wristband and an identifier of the second wireless transceiver module. The method further comprises the steps of receiving with the first wireless transceiver module, the broadcast packet from the second wireless transceiver module; and detecting the handshake with the first processing unit, when the step of determining that the current state of the first electronic wristband indicates that the first electronic wristband is shaking, occurs at substantially the same time as the step of receiving the broadcast packet.

Preferably the step of determining that the current state of the first electronic wristband indicates that the first electronic wristband is shaking comprises the step of detecting at least three positive-to-negative cycles in the X-axis or Y-axis or Z-axis direction from the acceleration readings.

Preferably the step of determining that the current state of the second electronic wristband indicates that the second electronic wristband is shaking comprises the step of detecting at least three positive-to-negative cycles in the X-axis or Y-axis or Z-axis direction from the acceleration readings.

Preferably the method further comprises the steps of pairing a first mobile device with the first wireless transceiver module; pairing a second mobile device with the second wireless transceiver module; communicatively connecting a server with the first mobile device and the second mobile device; and exchanging name card information between the first wireless transceiver module and the first mobile device pair, and the second wireless transceiver module and the second mobile device pair, via the server.

Preferably the method further comprises the step of implementing security checks prior to the exchange of name card information using the server.

Preferably the method further comprises the steps of locating with the first wireless transceiver module, the second wireless transceiver module via the identifier of the second wireless transceiver module; and establishing a peer to peer connection between the first wireless transceiver module and the second wireless transceiver module to exchange name card information.

Preferably the method further comprises the step of determining with the first processing unit, that the current state of the first electronic wristband indicates that the first electronic wristband is flipping, when the acceleration data indicates a change in orientation of the first accelerometer.

Preferably the method further comprises the steps of using a first altimeter to measure altitude data, the first altimeter comprised in the first electronic wristband; determining with the first processing unit and from the altitude data at the polling interval, the current state of the first electronic wristband; using a second altimeter to measure altitude data, the first altimeter comprised in the second electronic wristband; and determining with the second processing unit and from the altitude data at the polling interval, the current state of the second electronic wristband.

Preferably the method further comprises the step of determining with the first processing unit, that the current state of the first electronic wristband indicates that the first electronic wristband is being raised, when the altitude data indicate an increase in altitude greater than 0.5 meters.

Preferably the method further comprises the step of determining with the first processing unit, that the current state of the first electronic wristband indicates that the first electronic wristband is being lowered, when the altitude data indicate a decrease in altitude greater than 0.5 meters.

Preferably the first wireless transceiver module or the second wireless transceiver module is any one of the following: an ANT transceiver module, a Bluetooth LE transceiver module and a Wi-Fi transceiver module.

Preferably the identifier of the first wireless transceiver module or the identifier of the second wireless transceiver module is a MAC address.

Preferably the polling interval is every 200 milliseconds.

Preferably the broadcasting interval is every 300 milliseconds.

The invention will now be described in detail with reference to the accompanying drawings.

### BRIEF DESCRIPTION OF THE DRAWINGS

The accompanying figures illustrate disclosed embodiment(s) and serve to explain principles of the disclosed embodiment(s). It is to be understood, however, that these drawings are presented for purposes of illustration only, and not for defining limits of the application.

FIG. 1 shows a schematic diagram of a system for detecting a handshake according to a preferred embodiment.

FIG. 2 shows the components of the first electronic wristband.

FIG. 3 shows the components of the second electronic wristband.

FIG. 4 shows exemplary acceleration data.

FIG. 5 shows broadcast packets as used in the invention.

FIG. 6 shows a flowchart of a method for detecting a handshake according to a preferred embodiment.

FIG. 7 shows a flowchart of a method for detecting a handshake according to another preferred embodiment.

FIG. 8 shows a schematic diagram of a system for detecting a handshake according to another preferred embodiment.

FIG. 9 shows a flowchart of a method for detecting a handshake according to another preferred embodiment.

Exemplary, non-limiting embodiments of the present application will now be described with references to the above-mentioned figures.

### DETAILED DESCRIPTION

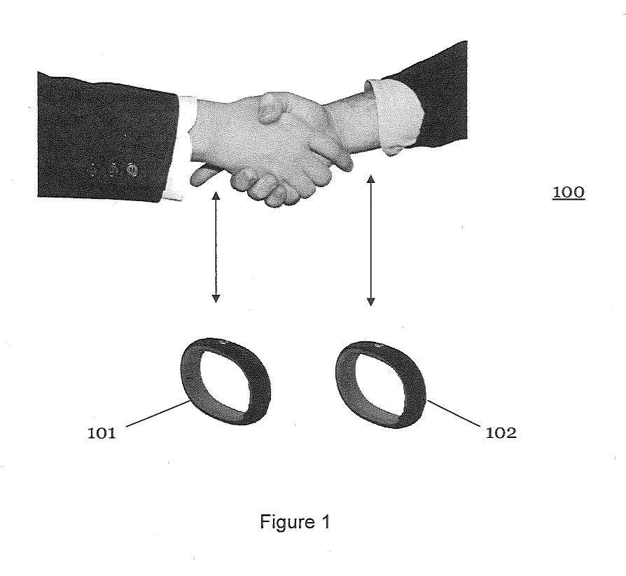

FIG. 1 shows system 100 for exchanging data. System 100 comprises first electronic wristband 101 and second electronic wristband 102.

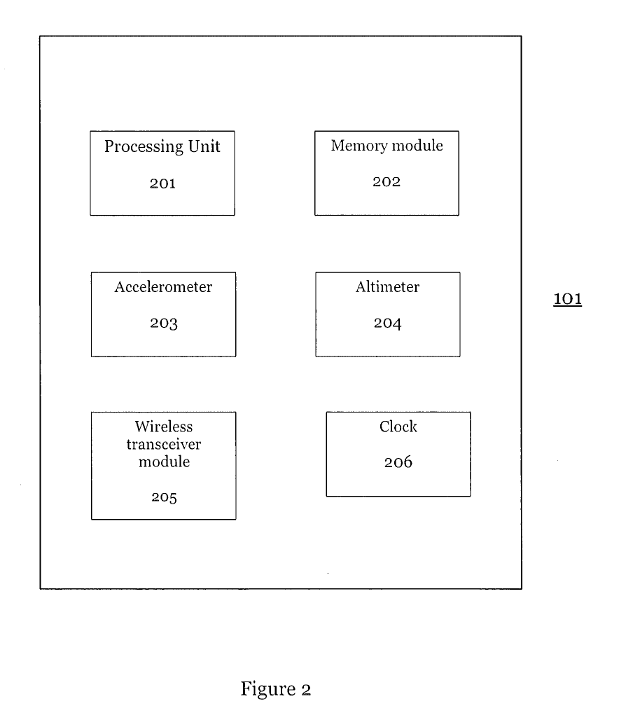

FIG. 2 shows the components of first electronic wristband 101. First electronic wristband 101 comprises processing unit 201, memory module 202, accelerometer 203 and altimeter 204. First electronic wristband 101 further comprises wireless transceiver module 205 and clock 206.

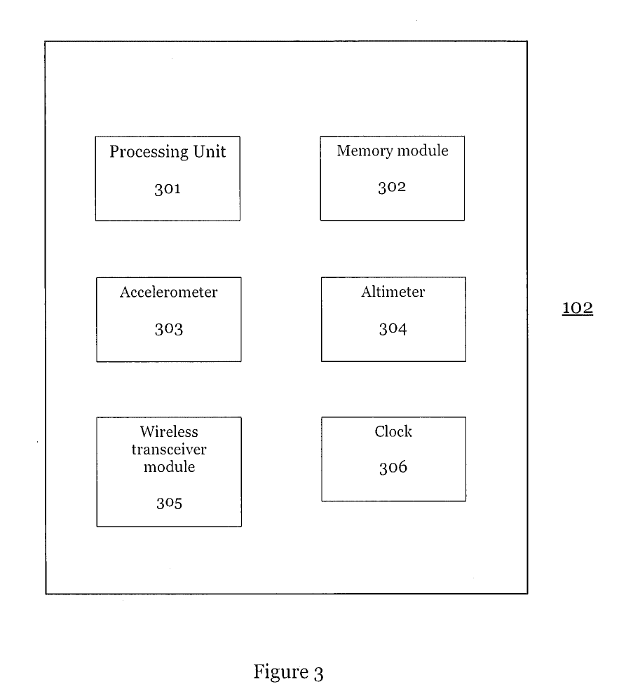

Second electronic wristband 102 has the same components as first electronic wristband 101. Namely, and as shown in FIG. 3, second electronic wristband 102 comprises processing unit 301, memory module 302, accelerometer 303 and altimeter 304. Second electronic wristband 102 further comprises wireless transceiver module 305 and clock 306.

Wireless transceiver modules 205, 305 can have an antenna, and operate at a frequency of 2.4 GHz, with a range of 10 meters. Wireless transceiver modules 205, 305 can operate with very low power by using a very short duty-cycle and deep-sleep technique. The throughput of wireless transceiver modules 205, 305 can be 20 kbps. Each wireless transceiver module 205, 305 can operate as a slave or as a master. Wireless transceiver modules 205, 305 can operate in a broadcast mode. In the broadcast mode, wireless transceiver modules 205, 305 send broadcast packets to other wireless transceiver modules 205, 305 within its range. Wireless transceiver modules 205, 305 can also operate in a connection mode. In the connection mode, wireless transceiver module 205 connects directly to wireless transceiver module 305 in a peer to peer connection.

Wireless transceiver modules 205, 305 can be ANT transceiver modules that operate under the ANT protocol or the like. Alternatively, wireless transceiver modules 205, 305 can be Bluetooth LE transceiver modules that operate under the Bluetooth LE protocol or the like. Alternatively, wireless transceiver modules 205, 305 can be Wi-Fi transceiver modules that operate under the Wi-Fi protocol or the like.

Accelerometers 203, 303 measure acceleration data. Accelerometers 203, 303 can be tri-axis accelerometers. Altimeters 204, 304 measure altitude values. Altimeters 204, 304 can measure the altitude values taking reference from the dead-sea level. Clocks 206 and 306 keep time.

Processing units 201, 301 can be microprocessors. Stored within memory modules 202, 302 could be the person's name card information i.e. name, company, designation, company address, email address, hand-phone number, office number, photograph etc. Memory modules 202, 302 can also store acceleration data provided by accelerometers 203, 303 and altitude data provided by altimeters 204, 304.

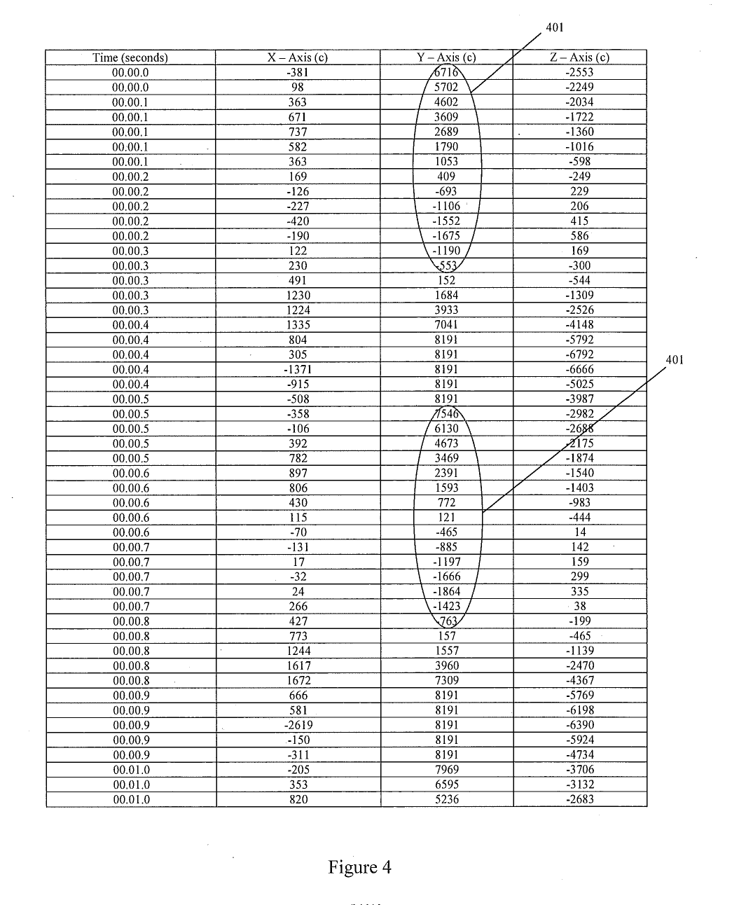

Processing units 201, 301 can retrieve the acceleration data from accelerometers 203, 303 at a polling interval or upon an interrupt. This polling interval can be every 200 milliseconds. FIG. 4 provides some exemplary acceleration data. In FIG. 4, positive and negative values denote the direction of the acceleration and (c) is the scale quantize value constant. 401 represent positive-to-negative cycles.

Based on the retrieved acceleration data, processing units 201, 301 can compute or determine a STATE of first electronic wristband 101, second electronic wristband 102. For example:
If processing units 201, 301 detect at least three positive-to-negative cycles 401 in the X-axis, Y-axis or Z-axis direction, processing units 201, 301 would set a STATE of first electronic wristband 101, second electronic wristband 102 to be “SUSPECTED SHAKE”.
If processing units 201, 301 do not detect a change in acceleration in the X-axis, Y-axis or Z-axis direction for a few seconds, processing units 201, 301 would set a STATE of first electronic wristband 101, second electronic wristband 102 to be “NO ACTION”.
If processing units 201, 301 detect a change in orientation of the accelerometer, processing units 201, 301 would set a STATE of first electronic wristband 101, second electronic wristband 102 to be “FLIP”.

The STATE of first electronic wristband 101, second electronic wristband 102 is computed by processing units 201, 301 at every polling interval so as to establish the “current” STATE of first electronic wristband 101, second electronic wristband 102. The STATE of first electronic wristband 101, second electronic wristband 102 can be coded as a byte and saved in memory modules 202, 302.

In an alternative embodiment, the STATE of first electronic wristband 101, second electronic wristband 102 can be computed or determined by processing units 201, 301 using the altitude data instead of the acceleration data. Processing units 201, 301 can retrieve the altitude data from altimeters 204, 304 at a polling interval or upon at interrupt. This polling interval can be every 200 milliseconds.

Based on the retrieved altitude data, processing units 201, 301 can compute or determine a STATE of first electronic wristband 101, second electronic wristband 102. For example:
If processing units 201, 301 detect a fluctuation in altitude and sustained for a few seconds, processing units 201, 301 would set a STATE of first electronic wristband 101, second electronic wristband 102 to be “SUSPECTED SHAKE”.
If processing units 201, 301 detect an increase in altitude greater than 0.5 meters and sustained for a few seconds, processing units 201, 301 would set a STATE of first electronic wristband 101, second electronic wristband 102 to be “RAISE HAND”.
If processing units 201, 301 detect a decrease in altitude greater than 0.5 m and sustained for a few seconds, processing units 201, 301 would set a STATE of first electronic wristband 101, second electronic wristband 102 to be “LOWER HAND”.

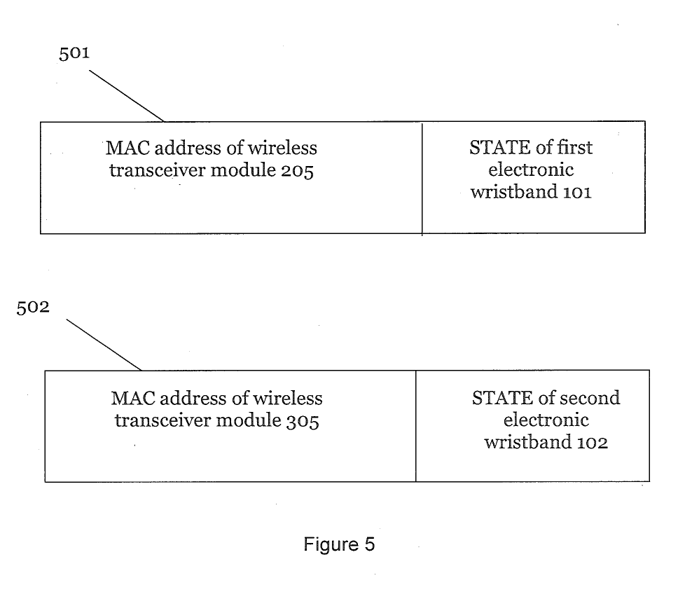

In the broadcast mode, wireless transceiver modules 205, 305 send broadcast packets 501, 502 at a broadcasting interval. The broadcasting interval can be longer than the polling interval. This broadcasting interval can be every 300 milliseconds. Broadcast packets 501, 502 (referring to FIG. 5) include the STATE of first electronic wristband 101, second electronic wristband 102. Broadcast packets 501, 502 can also include the media access control address (MAC address) of wireless transceiver modules 205, 305, or alternatively a serial number, or IP address, or an identifier to uniquely identify wireless transceiver modules 205, 305.

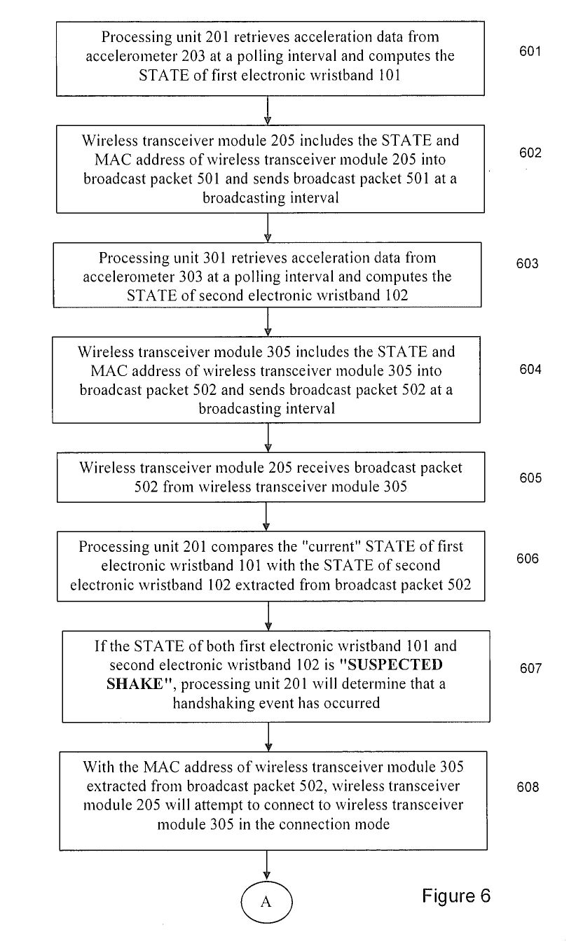

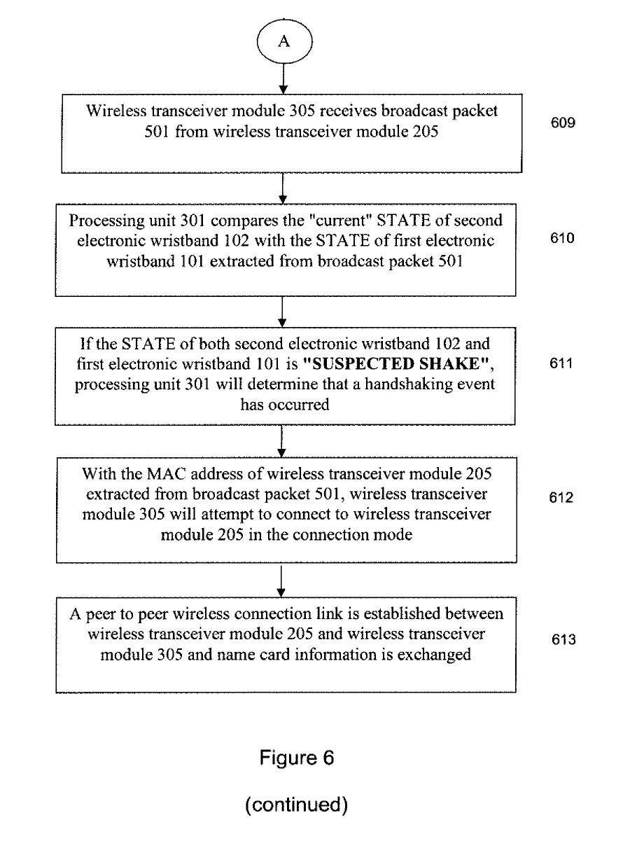

FIG. 6 illustrates a method of detecting a handshake in accordance with a preferred embodiment. First electronic wristband 101 is worn by a first person while second electronic wristband 102 is worn by a second person.

Referring to step 601, processing unit 201 retrieves acceleration data from accelerometer 203 at a polling interval or upon an interrupt and computes the STATE of first electronic wristband 101.

In step 602, wireless transceiver module 205 includes the STATE and MAC address of wireless transceiver module 205 into broadcast packet 501 and sends broadcast packet 501 at a broadcasting interval. Alternatively, instead of MAC address of wireless transceiver module 205, a serial number, or IP address, or an identifier to uniquely identify wireless transceiver module 205 can be included into broadcast packet 501. One skilled in the art would appreciate that the key point is that the broadcast packet 501 must include some form of identifier that uniquely identifies wireless transceiver module 205.

In step 603, processing unit 301 retrieves acceleration data from accelerometer 303 at a polling interval or upon an interrupt and computes the STATE of second electronic wristband 102.

In step 604, wireless transceiver module 305 includes the STATE and MAC address of wireless transceiver module 305 into broadcast packet 502 and sends broadcast packet 502 at a broadcasting interval. Alternatively, instead of MAC address of wireless transceiver module 305, a serial number, or IP address, or an identifier to uniquely identify wireless transceiver module 305 can be included into broadcast packet 502. One skilled in the art would appreciate that the key point is that the broadcast packet 502 must include some form of identifier that uniquely identifies wireless transceiver module 305.

In step 605, wireless transceiver module 205 receives broadcast packet 502 from wireless transceiver module 305.

In step 606, processing unit 201 compares the “current” STATE of first electronic wristband 101 with the STATE of second electronic wristband 102 extracted from broadcast packet 502.

In step 607, if the STATE of both first electronic wristband 101 and second electronic wristband 102 is “SUSPECTED SHAKE”, processing unit 201 will determine that a handshaking event has occurred.

In step 608, with the MAC address of wireless transceiver module 305 extracted from broadcast packet 502, wireless transceiver module 205 will attempt to connect to wireless transceiver module 305 in the connection mode.

In step 609, wireless transceiver module 305 receives broadcast packet 601 from wireless transceiver module 205.

In step 610, processing unit 301 compares the “current” STATE of second electronic wristband 102 with the STATE of first electronic wristband 101 extracted from broadcast packet 501.

In step 611, if the STATE of both second electronic wristband 102 and first electronic wristband 101 is “SUSPECTED SHAKE”, processing unit 301 will determine that a handshaking event has occurred.

In step 612, with the MAC address of wireless transceiver module 205 extracted from broadcast packet 501, wireless transceiver module 305 will attempt to connect to wireless transceiver module 205 in the connection mode.

In step 613, a peer to peer wireless connection link is established between wireless transceiver module 205 and wireless transceiver module 305 and name card information is exchanged.

The invention as disclosed thus works on the principle that if two “neighboring” electronic wristbands 101, 102 both have a substantially synchronized STATE of “SUSPECTED SHAKE”, a handshake event would be deemed to have occurred. Processing units 201, 301 are computing the STATE of electronic wristbands 101, 102 while wireless transceiver modules 205, 305 are sending and receiving broadcast packets 501, 502 with the STATE. Time is a crucial element here. Only when processing unit 201 receives a broadcast packet 502 reporting that the STATE of second electronic wristband 102 is “SUSPECTED SHAKE” at substantially the same time as when processing unit 201 computes a STATE of “SUSPECTED SHAKE”, will processing unit 201 deem that a handshake event has occurred. In other words, only when the STATE of “SUSPECTED SHAKE” of electronic wristbands 101, 102 are synchronized or substantially, synchronized (there is an inherent delay in the sending and receiving of broadcast packets 501, 502), will processing unit 201 deem that a handshake event has occurred. Along the same lines, only when processing unit 301 receives a broadcast packet 501 reporting that the STATE of first electronic wristband 101 is “SUSPECTED SHAKE” at substantially the same time as when processing unit 301 computes a STATE of “SUSPECTED SHAKE”, will processing unit 301 deem that a handshake event has occurred.

The invention therefore succeeds in being able to detect a synchronized or substantially synchronized “shake”. Further, one skilled in the art would understand that the invention can be easily adapted to detect a synchronized or substantially synchronized “raising of hand”, and a synchronized or substantially synchronized “lowering of hand”, and a synchronized or substantially synchronized “flipping of hand”.

Further, the invention is advantageous as broadcast packets 501, 502 only report the STATE of electronic wristbands 101, 102, which can be coded within a byte. The raw data (i.e. acceleration data) are not sent in the broadcast packets 501, 502. This is because this invention is envisioned to work with a low powered form of wireless communication (e.g. ANT, Bluetooth LE, Wi-Fi or the like) which therefore has low bandwidth. Further, as wireless transceiver modules 205, 305 are sending broadcast packets 501, 502 as a high rate (broadcasting interval), it is imperative that the size of broadcast packets 501, 502 are as small as possible.

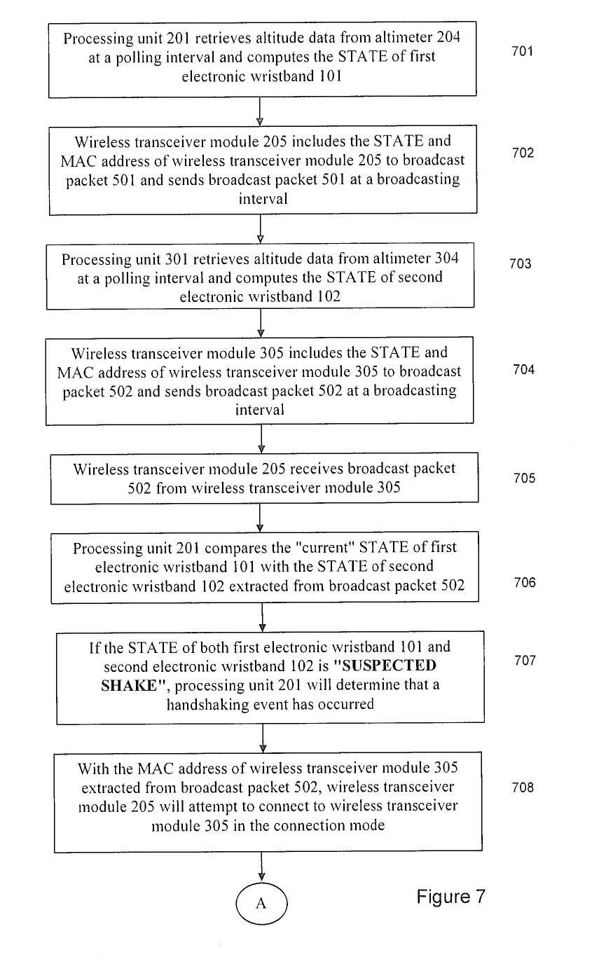

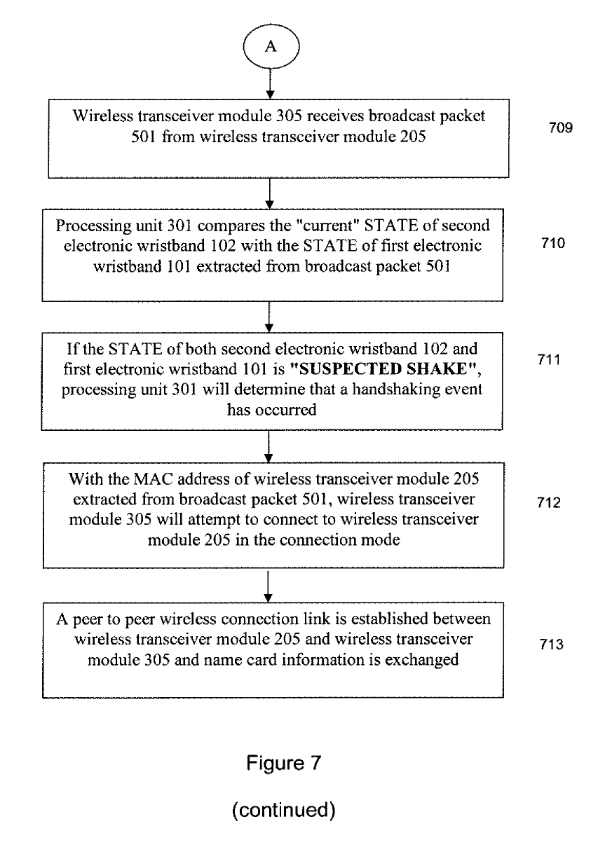

In another preferred embodiment, as shown in FIG. 7, altitude data from altimeters 204, 304, are used to detect a handshake instead of acceleration data from accelerometers 203, 303.

Referring to step 701, processing unit 201 retrieves altitude data from altimeter 204 at a polling interval or upon an interrupt and computes the STATE of first electronic wristband 101.

In step 702, wireless transceiver module 205 includes the STATE and MAC address of wireless transceiver module 205 into broadcast packet 501 and sends broadcast packet 501 at a broadcasting interval.

In step 703, processing unit 301 retrieves altitude data from altimeter 304 at a polling interval or upon an interrupt and computes the STATE of second electronic wristband 102.

In step 704, wireless transceiver module 305 includes the STATE and MAC address of wireless transceiver module 305 into broadcast packet 502 and sends broadcast packet 502 at a broadcasting interval.

In step 705, wireless transceiver module 205 receives broadcast packet 502 from wireless transceiver module 305.

In step 706, processing unit 201 compares the “current” STATE of first electronic wristband 101 with the STATE of second electronic wristband 102 extracted from broadcast packet 502.

In step 707, if the STATE of both first electronic wristband 101 and second electronic wristband 102 is “SUSPECTED SHAKE”, processing unit 201 will determine that a handshaking event has occurred.

In step 708, with the MAC address of wireless transceiver module 305 extracted from broadcast packet 502, wireless transceiver module 205 will attempt to connect to wireless transceiver module 305 in the connection mode.

In step 709, wireless transceiver module 305 receives broadcast packet 501 from wireless transceiver module 205.

In step 710, processing unit 301 compares the “current” STATE of second electronic wristband 102 with the STATE of first electronic wristband 101 extracted from broadcast packet 501.

In step 711, if the STATE of both second electronic wristband 102 and first electronic wristband 101 is “SUSPECTED SHAKE”, processing unit 301 will determine that a handshaking event has occurred.

In step 712, with the MAC address of wireless transceiver module 205 extracted from broadcast packet 501, wireless transceiver module 305 will attempt to connect to wireless transceiver module 205 in the connection mode.

In step 713, a peer to peer wireless connection link is established between wireless transceiver module 205 and wireless transceiver module 305 and name card information is exchanged.

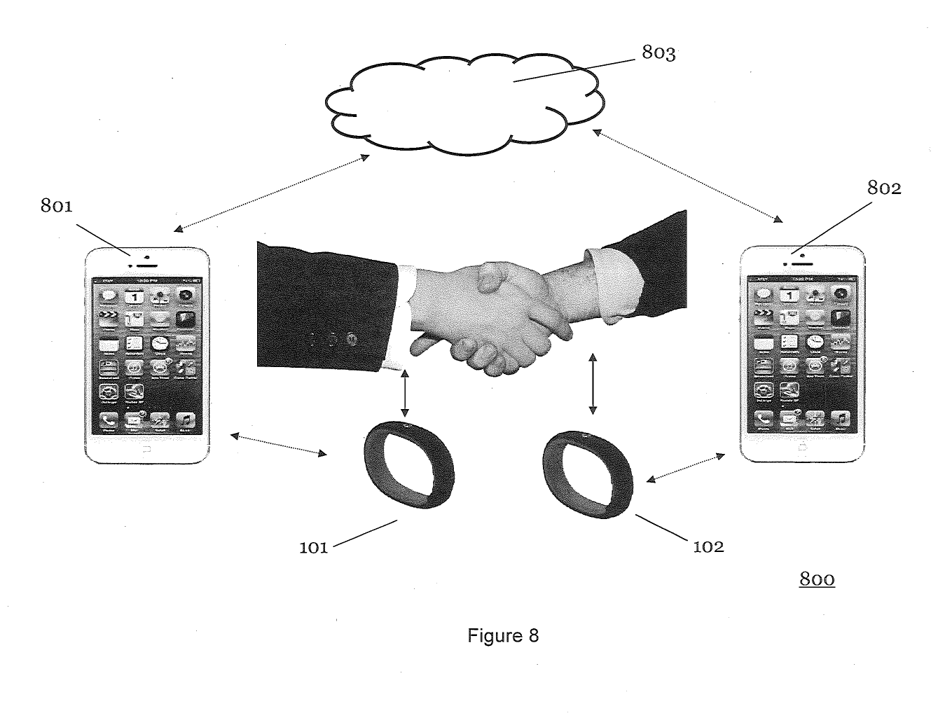

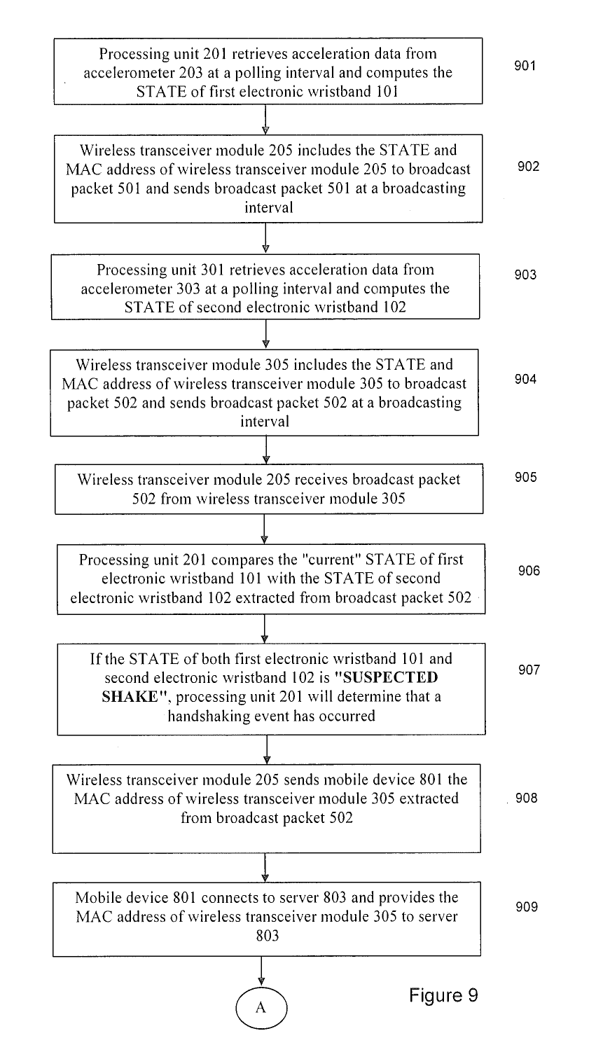

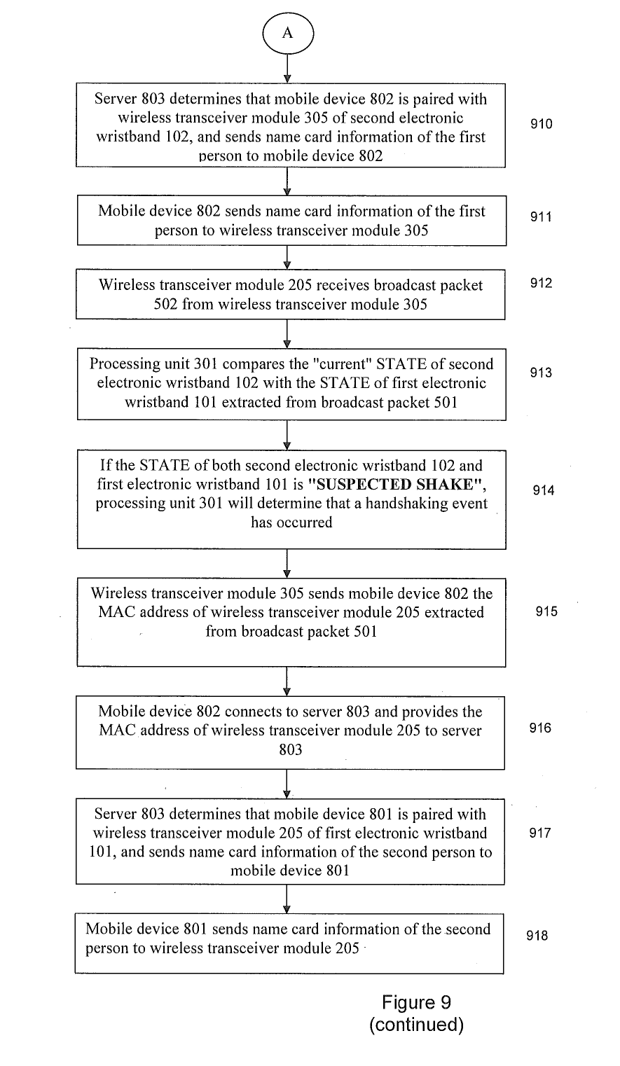

In yet another preferred embodiment, instead of establishing a peer to peer connection between wireless transceiver module 205 and wireless transceiver module 305 for the name card information transfer (as depicted in steps 613 and 713 of FIGS. 6 and 7), system 800 uses mobile device 801, mobile device 802 and server 803 (see FIG. 8). First electronic wristband 101 is worn by a first person while second electronic wristband 102 is worn by a second person. Mobile device 801 and mobile device 802 is communicatively connectable to server 803. Mobile device 801 is “paired” with first electronic wristband 101 and mobile device 802 is “paired” with second electronic wristband 102. FIG. 9 describes a method for implementing system 800.

In step 901, processing unit 201 retrieves acceleration data from accelerometer 203 at a polling interval or upon an interrupt and computes the STATE of first electronic wristband 101.

In step 902, wireless transceiver module 205 includes the STATE and MAC address of wireless transceiver module 205 into broadcast packet 501 and sends broadcast packet 501 at a broadcasting interval.

In step 903, processing unit 301 retrieves acceleration data from accelerometer 303 at a polling interval or upon an interrupt and computes the STATE of second electronic wristband 102.

In step 904, wireless transceiver module 305 includes the STATE and MAC address of wireless transceiver module 305 into broadcast packet 502 and sends broadcast packet 502 at a broadcasting interval.

In step 905, wireless transceiver module 205 receives broadcast packet 502 from wireless transceiver module 305.

In step 906, processing unit 201 compares the “current” STATE of first electronic wristband 101 with the STATE of second electronic wristband 102 extracted from broadcast packet 502.

In step 907, if the STATE of both first electronic wristband 101 and second electronic wristband 102 is “SUSPECTED SHAKE”, processing unit 201 will determine that a handshaking event has occurred.

In step 908, wireless transceiver module 205 sends mobile device 801 the MAC address of wireless transceiver module 305 extracted from broadcast packet 502.

In step 909, mobile device 801 connects to server 803 and provides the MAC address of wireless transceiver module 305 to server 803. Via the connection, server 803 can identify the MAC address of wireless transceiver module 205, and retrieve the name card information of the first person from its database. This presupposes that some form of pre-registration with server 803 had been done and server 803 has on record an associated link between mobile device 801, the MAC address of wireless transceiver module 205 and the name card information of the first person. Once server 803 has retrieved the name card information of the first person from its database, server 803 can also provide additional checks for security purposes. For example, server 803 can send a prompt to mobile device 801, requesting the first person to confirm that the name card information is indeed to be sent. Alternatively, server 803 could prompt the first person to enter a password. These additional checks are for precautionary purposes in the off-chance that the handshake event is incorrectly detected, and to avoid the scenario where name card information is wrongly sent. These additional checks can also help to allay privacy concerns in the event that the first person or second person only wishes to disclose his contact information or name card information to selected persons.

In step 910, server 803 determines that mobile device 802 is paired with wireless transceiver module 305 of second electronic wristband 102, and sends name card information of the first person to mobile device 802. Again, this presupposes that some form of pre-registration with server 803 had been done and server 803 has on record an associated link between mobile device 802, the MAC address of wireless transceiver module 305 and the name card information of the second person.

In step 911, mobile device 802 sends name card information of the first person to wireless transceiver module 305.

In step 912, wireless transceiver module 205 receives broadcast packet 502 from wireless transceiver module 305.

In step 913, processing unit 301 compares the “current” STATE of second electronic wristband 102 with the STATE of first electronic wristband 101 extracted from broadcast packet 501.

In step 914, if the STATE of both second electronic wristband 102 and first electronic wristband 101 is “SUSPECTED SHAKE”, processing unit 301 will determine that a handshaking event has occurred.

In step 915, wireless transceiver module 305 sends mobile device 802 the MAC address of wireless transceiver module 205 extracted from broadcast packet 501.

In step 916, mobile device 802 connects to server 803 and provides the MAC address of wireless transceiver module 205 to server 803. Via the connection, server 803 can identify the MAC address of wireless transceiver module 305, and retrieve the name card information of the second person from its database. Once server 803 has retrieved the name card information of the second person from its database, server 803 can also provide additional checks for security purposes. For example, server 803 can send a prompt to mobile device 802, requesting the second person to confirm that the name card information is indeed to be sent. Alternatively, server 803 could prompt the second person to enter a password. These additional checks are for precautionary purposes in the off-chance that the handshake event is incorrectly detected, and to avoid the scenario where name card information is wrongly sent. These additional checks can also help to allay privacy concerns in the event that the first person or second person only wishes to disclose his contact information or name card information to selected persons.

In step 917, server 803 determines that mobile device 801 is paired with wireless transceiver module 205 of first electronic wristband 101, and sends name card information of the second person to mobile device 801.

In step 918, mobile device 801 sends name card information of the second person to wireless transceiver module 205.

The advantages of this embodiment are enhanced security. Server 803 functions as the repository for the name card information, and the transfer of the name card information is relinquished to server 803. Server 803 can therefore implement various authentication steps, like prompting the first or second person to enter a password. This reduces the scenarios where name card information is wrongly sent.

Although this embodiment is described with processing units 201, 301 retrieving acceleration data from accelerometers 203, 303, it will be readily apparent to a skilled person having knowledge of the disclosure in this specification and in particular FIG. 7, that the invention would also work with processing units 201, 301 retrieving altitude data from altimeters 204, 304.

In the application, unless specified otherwise, the terms “comprising”, “comprise”, and grammatical variants thereof, intended to represent “open” or “inclusive” language such that they include recited elements but also permit inclusion of additional, non-explicitly recited elements.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

1. A system for detecting a handshake comprising:
a first electronic wristband worn on a wrist of a first person, the first electronic wristband comprising:
a first processing unit and a first accelerometer, the first processing unit configured to receive acceleration data from the first accelerometer at a polling interval or upon an interrupt, and configured to determine at the polling interval, a current state of the first electronic wristband from the acceleration data;
a first wireless transceiver module, the first wireless transceiver module configured to send broadcast packets at a broadcasting interval to a second wireless transceiver module, wherein each broadcast packet contains the current state of the first electronic wristband and an identifier of the first wireless transceiver module; and
a second electronic wristband worn on a wrist of a second person, the second electronic wristband comprising:
a second processing unit and a second accelerometer, the second processing unit configured to receive acceleration data from the second accelerometer at the polling interval or upon an interrupt, and configured to determine at the polling interval, a current state of the second electronic wristband from the acceleration data;
the second wireless transceiver module, the second wireless transceiver module configured to send broadcast packets at the broadcasting interval to the first wireless transceiver module, wherein each broadcast packet contains the current state of the second electronic wristband and an identifier of the second wireless transceiver module;
wherein the first processing unit is configured to detect the handshake when, the current state of the first electronic wristband determined by the first processing unit indicates that the first electronic wristband is shaking, occurs at substantially the same time the first wireless transceiver module receives the broadcast packet from the second wireless transceiver module, wherein the current state of the second electronic wristband in the broadcast packet indicates that the second electronic wristband is shaking.

2. The system of claim 1 wherein the first processing unit determines that the current state of the first electronic wristband indicates that the first electronic wristband is shaking when the acceleration readings have at least three positive-to-negative cycles in the X-axis or Y-axis or Z-axis direction.

3. The system of claim 2 wherein the second processing unit determines that the current state of the second electronic wristband indicates that the second electronic wristband is shaking when the acceleration readings have at least three positive-to-negative cycles in the X-axis or Y-axis or Z-axis direction.

4. The system of claim 1 further comprising a first mobile device paired with the first wireless transceiver module, a second mobile device paired with the second wireless transceiver module, and a server, the server communicatively connected to the first mobile device and the second mobile device, wherein the first wireless transceiver module and first mobile device pair, and the second wireless transceiver module and second mobile device pair, exchange name card information via the server.

5. The system of claim 4 wherein the server is configured to implement security checks prior to the exchange of name card information.

6. The system of claim 4 wherein the first wireless transceiver module is further configured to locate the second wireless transceiver module via the identifier of the second wireless transceiver module, and configured to establish a peer to peer connection with the second wireless transceiver module to exchange name card information.

7. The system of claim 1 wherein the first processing unit determines that the current state of the first electronic wristband indicates that the first electronic wristband is flipping, when the acceleration data indicates a change in orientation of the first accelerometer.

8. The system of claim 1:
wherein the first electronic wristband further comprises a first altimeter, and the first processing unit is further configured to receive altitude data from the first altimeter at the polling interval, and further configured to determine the current state of the first electronic wristband from the altitude data; and
wherein the second electronic wristband further comprises a second altimeter, and the second processing unit is further configured to receive altitude data from the second altimeter at the polling interval, and further configured to determine the current state of the second electronic wristband from the altitude data.

9. The system of claim 8 wherein the first processing unit determines that the current state of the first electronic wristband indicates that the first electronic wristband is being raised, when the altitude data indicate an increase in altitude greater than 0.5 meters.

10. The system of claim 8 wherein the first processing unit determines that the current state of the first electronic wristband indicates that the first electronic wristband is being lowered, when the altitude data indicate a decrease in altitude greater than 0.5 meters.

11. The system of claim 1 wherein the first wireless transceiver module or the second wireless transceiver module is any one of the following: an ANT transceiver module, a Bluetooth LE transceiver module and a Wi-Fi transceiver module.

12. The system of claim 1 wherein the identifier of the first wireless transceiver module or the identifier of the second wireless transceiver module is a MAC address.

13. The system of claim 1 wherein the polling interval is every 200 milliseconds.

14. The system of claim 1 wherein the broadcasting interval is every 300 milliseconds.

15. A method for detecting a handshake comprising the steps of:
using a first accelerometer to measure acceleration data, the first accelerometer comprised in a first electronic wristband worn on a wrist of a first person, the first electronic wristband further comprising a first processing unit and a first wireless transceiver module;
determining with the first processing unit and from the acceleration data at a polling interval, that a current state of the first electronic wristband indicates that the first electronic wristband is shaking;
sending with the first wireless transceiver module, broadcast packets at a broadcasting interval to a second wireless transceiver, wherein each broadcast packet contains the current state of the first electronic wristband and an identifier of the first wireless transceiver module;
using a second accelerometer to measure acceleration data, the second accelerometer comprised in a second electronic wristband worn on a wrist of a second person, the second electronic wristband further comprising a second processing unit and the second wireless transceiver;
determining with the second processing unit and from the acceleration data at the polling interval, that a current state of the second electronic wristband indicates that the second electronic wristband is shaking;
sending with the second wireless transceiver module, broadcast packets at the broadcasting interval to the first wireless transceiver, wherein each broadcast packet contains the current state of the second electronic wristband and an identifier of the second wireless transceiver module;
receiving with the first wireless transceiver module, the broadcast packet from the second wireless transceiver module; and
detecting the handshake with the first processing unit, when the step of determining that the current state of the first electronic wristband indicates that the first electronic wristband is shaking, occurs at substantially the same time as the step of receiving the broadcast packet.

16. The method of claim 15 wherein the step of determining that the current state of the first electronic wristband indicates that the first electronic wristband is shaking comprises the step of detecting at least three positive-to-negative cycles in the X-axis or Y-axis or Z-axis direction from the acceleration readings.

17. The method of claim 16 wherein the step of determining that the current state of the second electronic wristband indicates that the second electronic wristband is shaking comprises the step of detecting at least three positive-to-negative cycles in the X-axis or Y-axis or Z-axis direction from the acceleration readings.

18. The method of claim 15 further comprising the steps of:
pairing a first mobile device with the first wireless transceiver module;
pairing a second mobile device with the second wireless transceiver module;
communicatively connecting a server with the first mobile device and the second mobile device; and
exchanging name card information between the first wireless transceiver module and the first mobile device pair, and the second wireless transceiver module and the second mobile device pair, via the server.

19. The method of claim 18 further comprising the step of implementing security checks prior to the exchange of name card information using the server.

20. The method of claim 15 further comprising the steps of:
locating with the first wireless transceiver module, the second wireless transceiver module via the identifier of the second wireless transceiver module; and
establishing a peer to peer connection between the first wireless transceiver module and the second wireless transceiver module to exchange name card information.

21. The method of claim 15 further comprising the step of:
determining with the first processing unit, that the current state of the first electronic wristband indicates that the first electronic wristband is flipping, when the acceleration data indicates a change in orientation of the first accelerometer.

22. The method of claim 15 further comprising the steps of:
using a first altimeter to measure altitude data, the first altimeter comprised in the first electronic wristband;
determining with the first processing unit and from the altitude data at the polling interval, the current state of the first electronic wristband;
using a second altimeter to measure altitude data, the first altimeter comprised in the second electronic wristband; and
determining with the second processing unit and from the altitude data at the polling interval, the current state of the second electronic wristband.

23. The method of claim 22 further comprising the step of:
determining with the first processing unit, that the current state of the first electronic wristband indicates that the first electronic wristband is being raised, when the altitude data indicate an increase in altitude greater than 0.5 meters.

24. The method of claim 22 further comprising the step of:
determining with the first processing unit, that the current state of the first electronic wristband indicates that the first electronic wristband is being lowered, when the altitude data indicate a decrease in altitude greater than 0.5 meters.

25. The method of claim 15 wherein the first wireless transceiver module or the second wireless transceiver module is any one of the following: an ANT transceiver module, a Bluetooth LE transceiver module and a Wi-Fi transceiver module.

26. The method of claim 15 wherein the identifier of the first wireless transceiver module or the identifier of the second wireless transceiver module is a MAC address.

27. The method of claim 15 wherein the polling interval is every 200 milliseconds.

28. The method of claim 15 wherein the broadcasting interval is every 300 milliseconds.
